(19) United States
(12) Patent Application Publication
(10) Pub. No.: US 2024/0416457 A1
(43) Pub. Date: Dec. 19, 2024

(54) METHOD FOR PRODUCING AND INSPECTING A PREDETERMINED BREAKING LINE IN A VEHICLE INTERIOR TRIM PART

(71) Applicant: JENOPTIK Automatisierungstechnik GmbH, Jena (DE)

(72) Inventor: Andreas BODE-MOSIG, Jena (DE)

(21) Appl. No.: 18/742,295

(22) Filed: Jun. 13, 2024

(30) Foreign Application Priority Data
Jun. 16, 2023 (DE) 10 2023 115 790.6

(51) Int. Cl. B23K 26/359; B23K 26/082; G01V 8/20

(52) U.S. Cl. CPC B23K 26/359; B23K 26/082; G01V 8/20

(57) ABSTRACT

A method for producing a predetermined breaking line in a vehicle interior trim part using a scanning laser beam and inspecting the predetermined breaking line. A transmitted part of the laser beam is detected by individual sensors of a sensor matrix at the individual holes of the predetermined breaking line and individual measurement signals are formed. At least some of these individual measurement signals are stored when a total reference signal is reached by a total measurement signal and compared with the individual reference values assigned to the processing locations. The contour and position of the predetermined breaking line produced can be evaluated from the comparison.

### PRIORITY CLAIM

The present application claims priority to German Patent Application No. 10 2023 115 790.6, filed Jun. 16, 2023, which said application is incorporated by reference in its entirety herein.

### FIELD OF THE INVENTION

The invention relates to a method for producing a predetermined breaking line in a vehicle interior trim part and for inspecting the contour and position of the predetermined breaking line.

The method is carried out using a device which includes a sensor matrix and a laser scanning device using which, during the production of the predetermined breaking line, a laser beam scanning over the vehicle interior trim part along the predetermined breaking line ablates material until a portion of the laser beam transmitted through the vehicle interior trim part is detected by individual sensors of the sensor matrix.

It should first be noted that, for the purposes of this description, a line along which the predetermined breaking line is generated is referred to as a predetermined breaking line, irrespective of the processing state.

### BACKGROUND OF THE INVENTION

The production of predetermined breaking lines in vehicle interior trim parts, e.g., for airbag openings in the dashboard, in the door trim or in the steering wheel hub or as breaking points on components protruding into the passenger compartment, such as cup holders, by means of lasers, has long been known. Due to the high requirements, on the one hand, for them to break open reliably if necessary and, on the other hand, for an aesthetic appearance of the equipment parts, so that a vehicle occupant should not perceive the predetermined breaking openings with the naked eye, material removal is performed in a sensor-monitored or sensor-controlled manner along a predetermined breaking line outlining the predetermined breaking opening.

It is also known for other applications, e.g. in the packaging industry, to introduce predetermined breaking lines as a separating aid in containers and the like by means of lasers.

In order to create a predetermined breaking line by laser material removal, slots or holes which do not extend completely through the vehicle interior trim part, or so-called microperforation holes which penetrate the vehicle interior trim part only with a very small hole, are introduced into the vehicle interior trim part concerned along a predetermined line. By means of the sensor monitoring or sensor control, respectively, either a reproducible remaining residual wall thickness or small holes with a reproducible diameter can be produced here, along the line forming the predetermined breaking line, by using the exceeding of a specified threshold value as a control parameter when detecting radiant energy transmitted through the residual wall or the hole. For this purpose, at least one sensor is arranged on a side of the vehicle interior trim part opposite the laser (visible side), which sensor detects, during processing, a transmitted portion of the processing laser beam when the vehicle interior trim part only has a specific residual wall thickness or already has a microhole within the predetermined breaking line at the respective processing point. The relative movement required for generating predetermined breaking lines can basically be generated by the laser beam as a tool or by the vehicle interior trim part, when the tool is stationary, with a method using the movement of the laser beam having proved to be easier to put into practice. Compared to robot-controlled guidance of a laser source above and along the predetermined breaking line, two or three-dimensional scanning of a laser beam along the predetermined breaking line is technically easy to implement and also permits significantly faster processing.

DE 10 2005 026 906 A1 discloses an interior trim part for vehicles and a method for manufacturing such an interior trim part. A device for carrying out the method comprises a laser with focusing optics and a scanner mirror system. A focus of a laser beam generated by the laser is located at a depth in the interior trim part, and material is removed at the focus.

DE 10 2005 054 607 A1 discloses a method for determining a residual layer thickness when forming blind holes or kerfs in components, wherein blind holes or kerfs are formed by means of laser radiation starting from one side of a component and the temperature on the opposite surface of the component is determined without contact by means of electromagnetic radiation emitted from this surface, and the residual layer thickness in the respective processing area of the laser radiation is thus determined.

A method disclosed in the patent document EP 1 118 421 B1 describes the production of a predetermined breaking line consisting of perforation holes by means of pulsed or continuous laser radiation. Processing optics direct the laser beam onto the rear surface of a vehicle interior trim part. Opposite, on the front surface of the vehicle interior trim part, a sensor is located in the beam path of the laser, i.e. on the optical axis of the processing optics. During a relative movement between the vehicle interior trim part and the processing optics along a predetermined breaking line to be generated, the laser emits a limited sequence of individual pulses, which partially overlap on the vehicle interior trim part, or continuous laser radiation of limited duration. This creates a slot with a continuously decreasing residual wall thickness in the vehicle interior trim part. The laser radiation is interrupted as soon as the sensor detects a breakthrough of the laser radiation on the front surface. If the required relative movement is to be performed by the laser, high-precision tracking of the sensor must be implemented so that the sensor axis and the optical axis of the processing optics always coincide.

Also according to EP 0 827 802 B1, a defined material removal down to a remaining residual wall thickness (material thickness) is ensured by a sensor detecting the transmitted radiation at the processing location from the outside. For this purpose, the sensor must be located on the optical axis of the laser beam directed at the vehicle interior trim part. No details are given here as to the implementation of the relative movement between the laser beam and the vehicle interior trim part required to generate the predetermined breaking line.

EP 3 321 024 A1 discloses a method and a device for producing a tear line in a flat workpiece along a predetermined contour by material removal using a laser. In the method, a workpiece is placed in a working area between an array of sensors and a laser scanner. The laser scanner scans a pulsed laser beam across a rear surface of the flat workpiece, along a tear line, causing material removal in the form of holes, each down to a predetermined residual wall thickness, at a plurality of removal locations along the tear line. Measurement signals generated by portions of the laser beam transmitted at the removal locations are recorded by individual sensors during material removal. Subsequently, a comparison signal is formed which is compared with a reference signal to which the predetermined residual wall thickness is assigned. The laser generator generating the laser pulses is controlled such that laser pulses impinge on the removal locations only until the predetermined residual wall thickness has been achieved. The transmitted laser radiation power of a laser pulse is detected when it is above a lower limit of the sensitivity range of the sensor, and the tear line can be positioned anywhere within a field of view of the array of sensors.

DE 10 2007 024 510 B3 discloses a device with a sensor arranged on the outside of the vehicle interior trim part to be processed, the measuring range of the sensor covering the entire predetermined breaking line. Here, the sensor is a matrix camera whose pixels can be read out individually. An associated control and computing unit is connected via signals to the sensor and a laser generator that generates the processing laser radiation. The control and computing unit is configured to store the location data of the pixels of the matrix camera in a manner assigned to the individual processing locations in order to read out only those pixels during processing that are assigned to the relevant processing location.

The vehicle interior trim part must be positioned in accordingly precise alignment with the sensor so that the individual processing locations along the predetermined breaking line assume a predetermined relative position to the respectively assigned pixels.

According to the method described in the above-mentioned DE 10 2007 024 510 B3, a predetermined breaking line is produced in a vehicle interior trim part by directing a laser beam onto an inner side of a vehicle interior trim part held stationary in a holding device, guiding the laser beam along a predetermined breaking line and effecting material removal in the form of holes with a residual wall thickness at a plurality of processing locations along the predetermined breaking line. In this process, measured values of predetermined pixels of a stationary sensor detecting the complete course of the predetermined breaking line on the outside of the vehicle interior trim part are recorded, said measured values being equivalent for the residual wall thickness. Depending on the measured values, a laser generator emitting the laser beam is controlled in comparison with at least one reference measured value. An essential feature of the method disclosed in the above-mentioned DE 10 2007 024 510 B3 is that only predetermined pixels of a matrix camera are read out to determine the measured values. In this case, the predetermined pixels are the pixels which are stored as receptive pixels assigned to the individual processing locations.

Advantageously, compared to the methods described, a method according to EP 10 2021 115 496 does not require the positioning of the vehicle interior trim part to be processed exactly opposite a sensor arrangement. Here, the vehicle interior trim part is arranged in a working plane between a sensor matrix and a laser scanning device and a laser beam is scanned along the predetermined breaking line, causing material to be removed in the form of holes down to a predetermined residual wall thickness at one respective processing location each along the predetermined breaking line. A transmitted portion of the laser beam successively causes individual measured values for individual sensors of the sensor matrix at one respective processing location at a time. A respective total measured value is formed from individual measured values recorded simultaneously and is compared with a total reference value to which the predetermined residual wall thickness is assigned. When the total measured value has reached the total reference value, the laser beam is switched off. A distinctive feature of the method disclosed here is that, at the start of the method, the actual position of the vehicle interior trim part in a coordinate system in relation to the laser scanner is determined using a camera whose relative position in the coordinate system is known, in order to adapt the stored coordinates for the predetermined breaking line to the real position of the vehicle interior trim part. Only the residual wall thickness along the predetermined breaking line can be inferred from the measured values of the sensor matrix.

### SUMMARY OF THE INVENTION

It is the object of the invention to find a method wherein the residual wall thickness in a predetermined breaking line is monitored by means of a sensor matrix and the contour and position of the predetermined breaking line on the vehicle interior trim part can be inspected without additional detection means.

This object is achieved by a method comprising the features of claim 1.

Advantageously, the stored individual measured values are compared not only with the individual reference values, but also with individual comparison values that are stored in a manner assigned to the relevant individual sensor and the relevant processing location and to which a position deviation from the target position is assigned. The actual position can thus be deduced from the individual measured values by interpolation.

In order to be able to determine the contour and the position of the predetermined breaking line with a low computational effort, the individual measured value is advantageously stored and compared for each processing location only for the individual sensors that have a center distance to the target position of the processing location that is smaller than the maximum extension of any individual sensor.

Alternatively, the individual measured value is advantageously stored and compared for each processing location precisely for the two individual sensors for which the highest individual reference value is recorded in comparison to the other individual reference values assigned to the processing location.

It is advantageous to be able to conclude that an individual sensor is defective if at least one of the individual sensors read out provides no individual measured value or an individual measured value that deviates by more than 50% from the associated individual reference value.

Advantageously, a negative deviation of an individual measured value from the assigned individual reference value can be used to infer a position deviation of the actual position of the processing location from its target position away from the center point of the individual sensor concerned, and a positive deviation of an individual measured value from the assigned individual reference value can be used to infer a position deviation of the actual position of the processing location from its target position towards the center point of the individual sensor concerned.

The actual position does not necessarily have to be determined for each processing location using the method steps according to the invention; instead, the actual position of individual processing locations can also be determined from the actual positions of adjacent processing locations.

More accurate results can be achieved if simultaneously recorded individual measured values are included in the total measured value with a different weighting depending on a different sensitivity and/or different response times of the individual sensors.

For a decision as to whether the vehicle interior trim part is a usable part, an upper limit for a number of position deviations outside a tolerance range is advantageously defined and the vehicle interior trim part is confirmed as a usable part if the upper limit is not exceeded.

For subsequent verification, it is advantageous if the actual positions of the processing locations are documented in relation to the target positions. Such documentation can also be a two-dimensional map in which the processing locations are entered locally and on which, for example, the individual reference values and individual measured values are plotted or the size of the individual measured values is reflected locally by corresponding color intensity.

### BRIEF DESCRIPTION OF THE DRAWINGS

The invention will be explained in more detail below with reference to exemplary embodiments and drawings. In the drawings:

FIG. 1 is a schematic representation of a prior art device for producing a predetermined breaking line in a vehicle interior trim part, and

FIG. 2 is a schematic representation of a sensor matrix and individual measured values formed for a processing location between four adjacent individual sensors.

### DETAILED DESCRIPTION

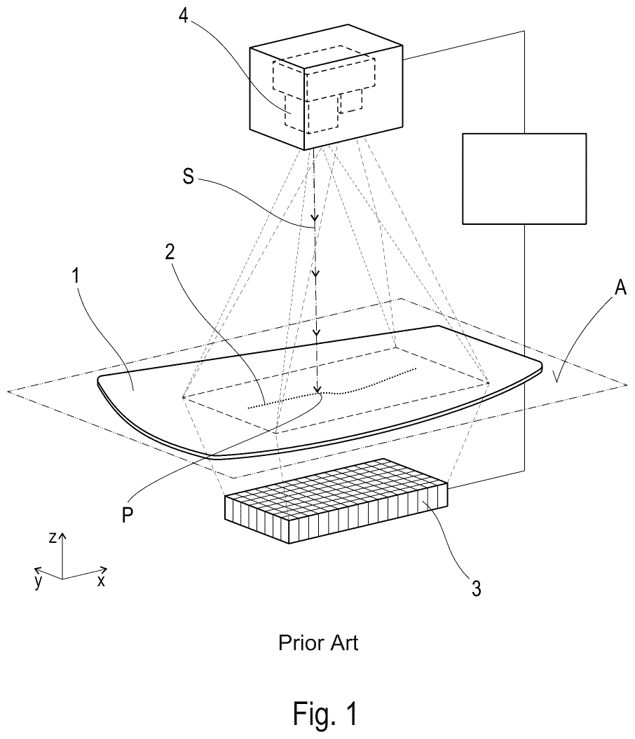

FIG. 1 shows a schematic representation of a prior art device for producing a predetermined breaking line 2 in a vehicle interior trim part 1, said device being suitable for performing the method. The device includes a sensor matrix 3, a processing head with a laser generator and a laser scanning device 4 arranged in a defined position in relation to it, as well as an intermediate working plane A, in which the vehicle interior trim part 1 to be processed is arranged in a defined position in relation to the sensor matrix 3 and the laser scanning device 4, as well as a control and computing unit, which is connected to the sensor matrix 3 and the laser scanning device via signals. The working plane A is adapted to the surface contour of the vehicle interior trim part 1 and need not be a geometric plane. Due to the defined arrangement in relation to the sensor matrix, it is known which individual sensors detect a transmitted laser beam when a hole is made in the predetermined breaking line if the predetermined breaking line is produced with a target contour in a target position. Individual reference values are stored for the target position of the individual holes assigned to the respective individual sensors.

The method starts by arranging a vehicle interior trim part 1 to be processed in the working plane A between the sensor matrix 3 and the laser scanning device 4 in a predetermined position relative to the sensor matrix 3. As a result, a predetermined breaking line 2 to be generated and the holes to be generated forming it also assume a predetermined position relative to the laser scanning device 4 and the sensor matrix 3, and thus to the individual sensors of the sensor matrix 3.

The laser scanning device 4 scans a laser beam S on an inner side of the vehicle interior trim part 1, along the predetermined breaking line 2, with material removal in the form of holes being effected in each case down to a predetermined residual wall thickness at respective processing locations P along the predetermined breaking line 2.

A portion of the laser beam S transmitted successively at the processing locations P results in individual measured values at individual sensors of the sensor matrix, at least some of which are recorded. A usual procedure is to record the individual measured values that are above a threshold value. Alternatively, the individual measured values of selected individual sensors can be recorded at and around the respective processing location P. The more individual measured values are included in the total measured value, the more independent the total measured value will be of the point of incidence of the laser beam (processing location).

A respective total measured value is formed for each respective processing location P from individual measured values recorded simultaneously and is compared in each case with a respective stored total reference measured value to which the predetermined residual wall thickness is assigned. When the total measured value has reached the total reference measured value, the laser beam is switched off.

It is essential to the invention that, when the total reference value is reached, at least some of the individual measured values of a respective total measured value are stored in a manner assigned to the respective individual sensor and the respective processing location and are each compared with a stored individual reference value assigned to the respective individual sensor and the respective processing location and any resulting deviations are used to evaluate the contour and position of the predetermined breaking line 2.

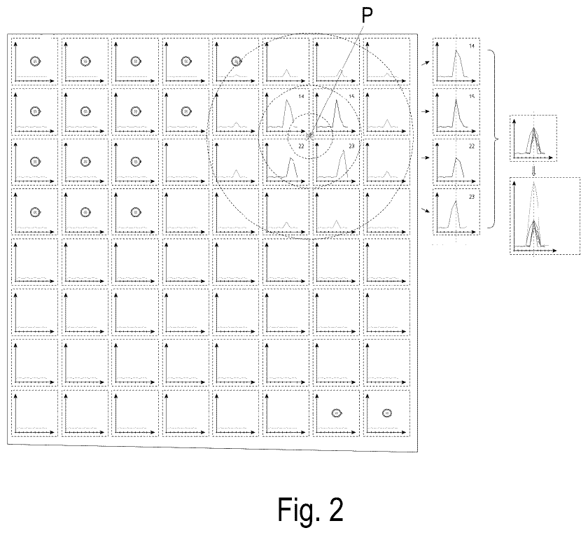

FIG. 2 shows a schematic representation of a sensor matrix and individual measured values assigned to a processing location P. In this example, the target position of the processing location P is exactly at the intersection point between four adjacent individual sensors. In principle, all individual measured values recorded for the formation of the total measured value can be stored and taken into account. Preferably, however, only the recorded individual measured values are also stored and taken into account for the comparison with individual reference values, which come from the individual sensors whose center distance to the target position of the processing location does not exceed a predetermined distance and is advantageously smaller than a maximum extension of an individual sensor, which is why in this example the individual measured values of the individual sensors 14, 15, 22 and 23 are taken into account and thus only the individual measured values of the four individual sensors located directly at the processing location P are stored. If the processing location P, relative to these individual sensors 14, 15, 22 and 23, is exactly where its target position is, then the individual measured values each correspond to the associated individual reference values. Deviations indicate a deviation of the actual position from the target position. If the actual position is shifted diagonally across the individual sensor 22, for example, the size of the individual measured value of the individual sensor 22 increases, while the size of the three individual measured values of the individual sensors 14, 15 and 23 decreases. In the example shown here, the total measured value is also only formed from these four individual measured values. In principle, the individual measured values from two individual sensors are sufficient to draw conclusions about a deviation in the position of the processing location from its target position when compared with the relevant individual reference values. With the requirement to use only the individual measured values of the individual sensors whose center distance to the target position of the processing location is smaller than a maximum extension of an individual sensor, the individual measured values of a maximum of six individual sensors are taken into account. Only in the special case where the processing location coincides exactly with the center point of a single sensor is only one individual measured value taken into account according to this requirement. In this case, the actual position for this processing location can be determined by interpolation from the determined actual positions of the adjacent processing locations.

If the residual wall thickness is to be constant over the entire predetermined breaking line, the same total reference value is stored for all processing locations P, which, however, results locally differently from a different number and different individual reference values. The different individual reference values enable the position to be determined.

Depending on the requirements placed on the quality evaluation, limit values for the permissible deviations of the observed individual measured values can be stored, for example, above which the hole created at the respective processing location P is evaluated with its actual position as out of tolerance.

Alternatively, in addition to the stored individual reference values that are assigned to the target position of the processing location P, individual comparison values can be stored with respect to the respective processing location P that are assigned to a specific position deviation of the processing location P from the target position. From the individual measured values obtained and stored at a processing location P, the actual position of the processing location P can thus be inferred by interpolation with the aid of the individual comparison values.

Individual measured values and, correspondingly, individual reference values and individual comparison values are values derived from the electrical signals generated by the individual sensors. These can be, for example, the signal amplitudes or the integral under the signal. The total measured value is calculated from the individual measured values by summing or other known processing rules. The individual measured values can be included with a different weighting. In the example shown in FIG. 2, the signal amplitudes are included in the total measured value with the same weighting, regardless of possible parameter tolerances of the individual sensors. More practically, the individual sensors are weighted differently. The weighting results from the characteristics of the individual sensors, such as their response behavior and sensitivity range, which are subject to fluctuation. The weighting is carried out in order to eliminate this fluctuation of the sensor parameters as far as possible.

In a special case, the target position of the processing location P is exactly centered horizontally and vertically between the individual sensors 14 and 15. The center-to-center distance of the adjacent individual sensors is greater here than the maximum extension of an individual sensor, which means that only the individual measured values of the individual sensors 14 and 15 are stored and compared with individual reference values. Here it becomes clear that the individual measured values of adjacent individual sensors must also be used to form the total measured value, as the desired residual wall thickness is reached much earlier than the total measured value reaches the total reference value if the processing location deviates significantly from the target position.

With the method according to the invention, the residual wall thickness still present at the respective processing locations is monitored and the processing of the holes at the processing locations is controlled by terminating the processing locally when a total reference value is reached by a total measured value. At the same time, a deviation of the actual position of the processing location from a target position is deduced from at least some of the individual measured values that make up the total measured value. Thus, not only can it be determined that there is a position deviation, but also whether this is within a specified tolerance or where the actual position is as a result of the position deviation. This information on the individual processing locations can be used to determine the contour and position of the predetermined breaking line on the vehicle interior trim part.

### LIST OF REFERENCE NUMERALS

1 vehicle interior trim part
2 predetermined breaking line
3 sensor matrix
P processing location
A working plane
S laser beam

1. A method for producing a predetermined breaking line in a vehicle interior trim part, wherein the vehicle interior trim part is arranged in a working plane between a sensor matrix and a laser scanning device at a known relative position to the sensor matrix and to the laser scanning device, the method comprising:
scanning with the laser scanning device a laser beam on an inner side of the vehicle interior trim part, along the predetermined breaking line, wherein material removal in the form of holes is successively effected in each case down to a predetermined residual wall thickness at respective processing locations along the predetermined breaking line;
successively transmitting a portion of the laser beam at the processing locations causing individual measured values for individual sensors of the sensor matrix, at least some of which are recorded; and
forming a respective total measured value for each respective processing location from individual measured values recorded simultaneously and comparing in each case with a respective stored total reference measured value to which the predetermined residual wall thickness is assigned;
when the total measured value has reached the total reference measured value, switching the laser beam off;
storing at least some of the recorded individual measured values of a respective total measured value when the latter reaches the total reference measured value, in a manner assigned to the respective individual sensor and the respective processing location, and comparing with a stored individual reference measured value assigned to the respective individual sensor and the respective processing location, which is assigned to a target position of the processing location, and using any resulting deviations to evaluate the contour and position of the predetermined breaking line.

2. The method according to claim 1, wherein:
an actual position of the respective processing location is derived from the simultaneously recorded, stored individual measured values of a total measured value that has reached the total reference measured value in each case and is compared with a target position stored for the respective processing location and the quality evaluation is carried out by inspecting the position and course of the produced predetermined breaking line.

3. The method according to claim 2, wherein:
the individual measured value is stored and compared for each processing location only for the individual sensors that have a center distance to the target position of the processing location that is smaller than the maximum extension of any individual sensor.

4. The method according to claim 2, wherein:
the individual measured value is stored and compared for each processing location precisely for the two individual sensors for which the highest individual reference measured value, in comparison to the other individual reference measured values assigned to the processing location, is recorded.

5. The method according to claim 1, wherein:
an individual sensor is concluded to be defective if at least one of the individual sensors read out provides no individual measured value or an individual measured value that deviates by more than 50% from the associated individual reference measured value.

6. The method according to claim 1, wherein:
a negative deviation of an individual measured value from the assigned individual reference measured value can be used to infer a position deviation of the actual position of the processing location from its target position away from the center point of the individual sensor concerned, and a positive deviation of an individual measured value from the assigned individual reference measured value can be used to infer a position deviation of the actual position of the processing location from its target position towards the center point of the individual sensor concerned.

7. The method according to claim 1, wherein:
at individual processing locations, their respective actual position is determined from the determined actual positions of adjacent processing locations.

8. The method according to claim 1, wherein:
the simultaneously recorded individual measured values are included in the overall measured value with a different weighting depending on a different sensitivity and/or different response times of the individual sensors.

9. The method according to claim 1, wherein:
an upper limit for a number of position deviations outside a tolerance range is defined and the vehicle interior trim part is confirmed as a usable part if the upper limit is not exceeded.

10. The method according to claim 1, wherein:
the actual positions of the processing locations are documented in relation to the target positions.
